(19) United States
(12) Patent Application Publication
(10) Pub. No.: US 2026/0091404 A1
(43) Pub. Date: Apr. 2, 2026

(54) Spray gun with angular indexing, associated ring, assembly and process

(71) Applicant: EXEL INDUSTRIES, EPERNAY (FR)

(72) Inventors: Paulo DOS SANTOS, AULNAY SOUS BOIS (FR); Airton DA GRACA, PANTIN (FR); Fabrice JOAQUIM, STAINS (FR)

(21) Appl. No.: 19/342,522

(22) Filed: Sep. 27, 2025

(30) Foreign Application Priority Data
Oct. 2, 2024 (FR) 2410604

(51) Int. Cl. B05B 15/68; B05B 1/04; B05B 13/02

(52) U.S. Cl. CPC B05B 15/68; B05B 13/0278; B05B 1/044

(57) ABSTRACT

A coating product spray gun including a body, a spray head, and a spray nozzle. The gun includes a ring connecting the spray head and the body, and an angular holding element of the angular position between the ring and the spray head. The gun includes a locking element movable between a locking position, wherein it locks the angular position of the ring relative to the body, and a release position, wherein it allows angular rotation of the ring relative to the body. An associated ring, assembly and method are also described and claimed.

### CROSS-REFERENCE TO RELATED APPLICATION

This application is a U.S. non-provisional application claiming the benefit of French Application No. 24 10604, filed on Oct. 2, 2024, which is incorporated herein by reference in its entirety.

### TECHNICAL FIELD OF THE INVENTION

This invention relates to a coating product spray gun including a body, a spray head, and a spray nozzle, the spray head defining a passage, the spray nozzle being arranged in the passage of the spray head.

The invention also relates to an associated ring, an assembly, and method.

### BACKGROUND OF THE INVENTION

The angular position of the spray head and the spray nozzle is adjustable relative to the gun body.

This is particularly important for the quality of the coating and to limit the loss of coating product outside a surface to be coated.

Once the adjustment of the angular position is made, it may be advantageous to maintain the angular position, particularly to avoid having to redo the adjustment.

A solution would then be to fix the spray head relative to the body.

However, in case of maintenance of the gun, and notably of the head and the nozzle, the head is disassembled from the body. Thus, the angular position is not maintained, and a new adjustment is necessary.

### SUMMARY OF THE INVENTION

The aim of the invention is to propose a spray gun allowing the maintenance of an angular position between the spray head and the body, including in case of maintenance.

To this end, the invention relates to a coating product spray gun including a body, a spray head, and a spray nozzle, the spray head defining a passage, the spray nozzle being arranged in the passage of the spray head, characterized in that the gun includes a ring, the ring connecting the spray head and the body, the gun including an angular holding element of the angular position between the ring and the spray head, the gun including a locking element, the locking element being movable between a locking position, in which it locks the angular position of the ring relative to the body, and a release position, in which it allows angular rotation of the ring relative to the body.

Thus, by means of the angular holding element, the angular position between the ring and the spray head is fixed. It is possible to adjust the angular position between the spray head and the body when the locking element is in the release position. When the angular position is correct, the locking element is moved to the locking position, so as to maintain the angular position between the ring and the body, and thus between the spray head and the body. In case of maintenance, the head may be detached from the ring, the ring remaining on the body in the angular position maintained by the locking element, then the head is reassembled on the ring in the angular position of the angular holding element.

According to other advantageous aspects of the invention, the gun includes one or more of the following features, taken individually or in any technically possible combination:
the locking element includes a rod provided with a shoulder, the rod moving between the locking position and the release position, such that, in the locking position, the shoulder exerts a force pressing the ring against the body in an axial direction;
the spray head has a main axis, the rod moving between the locking position and the release position in translation along the axial direction, the axial direction being parallel to the main axis of the spray head;
the body has an orifice opening onto a front face of the body, the ring extending against the front face of the body in the locking position of the locking element, the rod extending partially into the orifice, the body having an opening extending between a lateral face of the body and the orifice, so that the rod is accessible from the lateral face through the opening;
the gun includes a screw, the opening being threaded, the screw being arranged in the opening and being able to be screwed around a screwing axis to a position of holding the rod, wherein the screw extends against a recess of the rod, the recess having a chamfer, the chamfer being such that, when the screw is screwed to the position of holding the rod, the rod is moved towards the locking position;
the angular holding element of the angular position between the ring and the spray head also maintains the angular position between the spray head and the spray nozzle; and/or
the angular holding element of the angular position between the ring and the spray head includes at least one indexing element, the ring having at least one complementary cutout of the at least one indexing element, the spray head having at least one complementary hole of the at least one indexing element, each indexing element extending through the respective cutout and the respective hole.

The invention also relates to a ring adapted to extend between a body of a coating product spray gun and an assembly including a spray head and a spray nozzle, the ring having at least one complementary cutout of at least one indexing element, the at least one cutout being arranged so that an indexing element extending through the respective cutout is adapted to extend through a hole of the spray head.

The invention also relates to an assembly including a spray head for a coating product spray gun, the assembly further including at least one indexing element, the spray head having at least one complementary hole of the at least one indexing element, the spray head defining a rear side opposite the spraying of the coating product, the or each indexing element extending through the or a respective hole, protruding from the hole on the rear side then from the spray head in an axial direction of the spray head.

The invention also relates to a method of indexing an angular position between a body and a spray head of a gun as described above, including the following operations:
Providing the gun as described above, the locking element being in the release position,
Positioning the ring relative to the body in a relative angular position,
Moving the locking element to the locking position, so that the ring, and thus the spray head, are maintained in the relative angular position relative to the body.

### BRIEF DESCRIPTION OF THE DRAWINGS

The invention will become clearer upon reading the following description, given solely by way of non-limiting example, and made with reference to the drawings wherein:

FIG. 1 is a partial sectional view of a gun according to an embodiment of the invention;

FIG. 2 is a perspective view of the gun shown in FIG. 1, without the spray head;

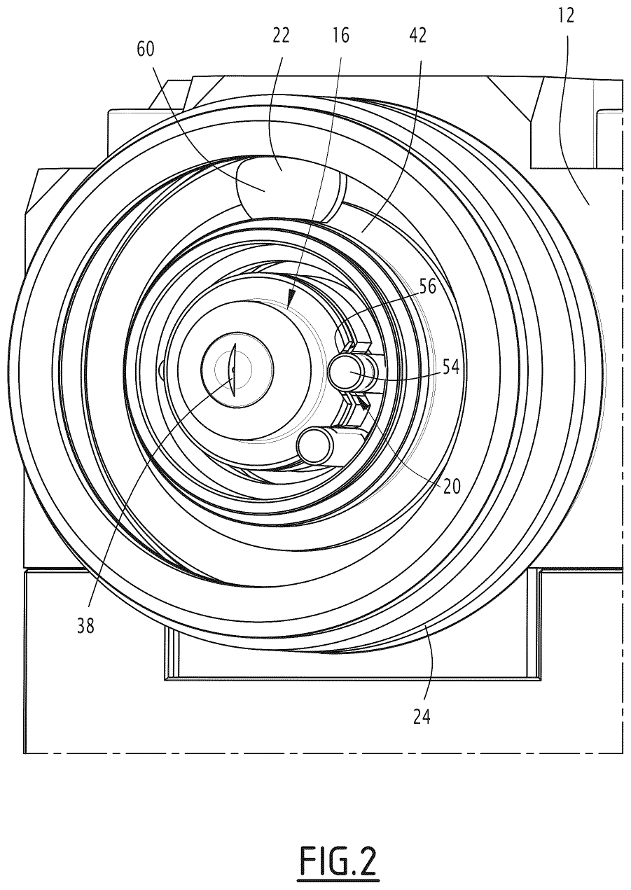

FIG. 3 is a perspective view of the ring of the gun shown in FIG. 1; and

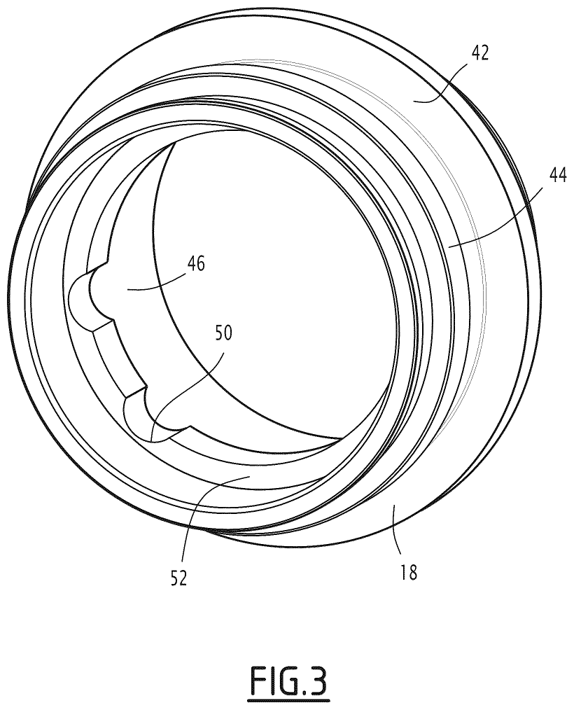

FIG. 4 is a perspective view of the head and indexing elements of the gun shown in FIG. 1.

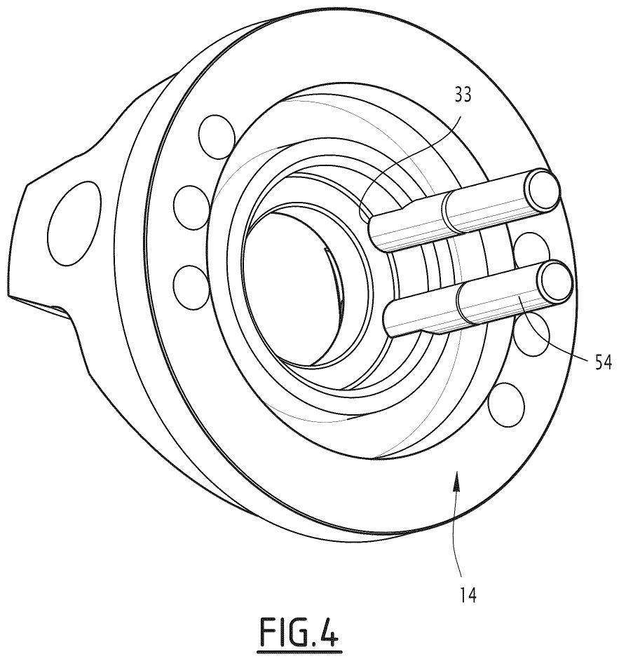

### DETAILED DESCRIPTION

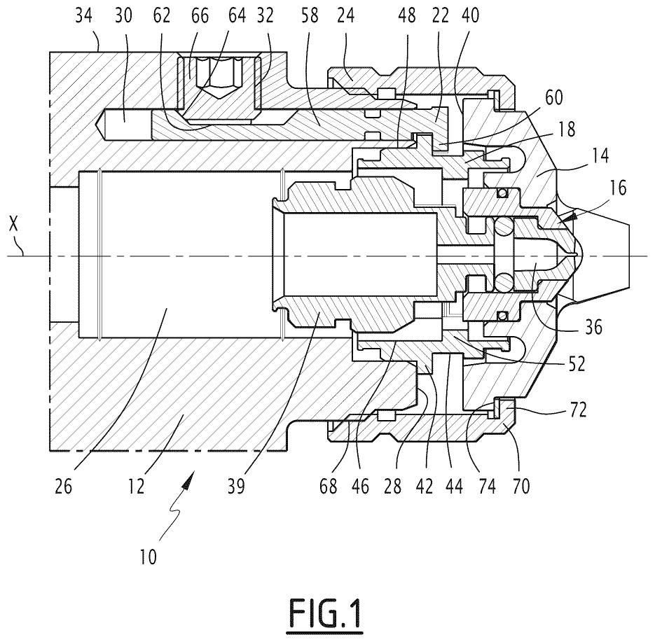

A coating product spray gun 10 according to an example of the invention is partially shown in FIG. 1.

The gun 10 includes a body 12, a spray head 14, a spray nozzle 16, and a ring 18.

The gun 10 further includes an angular holding element 20.

The gun 10 further includes a locking element 22.

The gun 10 further includes, in this embodiment, for example, an outer ring 24.

The body 12 is adapted to receive an assembly including the spray head 14 and the spray nozzle 16, more particularly, in this embodiment, including the spray head 14, the spray nozzle 16, and the ring 18.

The body 12 has, more particularly, a passage 26 for the coating product.

The passage 26 has a downstream outlet, on which is arranged the assembly including the spray head 14, the spray nozzle 16, and the ring 18.

The passage 26 at the outlet extends around a main axis X.

The body 12 has a front face 28, into which the outlet of the passage 26 opens in this embodiment.

The body 12 has, in this embodiment, an orifice 30 opening into the front face 28.

The orifice 30 extends, in this embodiment, parallel to the main axis X.

The orifice 30 extends, in this embodiment, perpendicularly to the front face 28.

The orifice 30 is, for example, blind.

The orifice 30 is, for example, cylindrical.

The body 12 also has, in this embodiment, an opening 32 extending between a lateral face 34 of the body 12 and the orifice 30.

The opening 32 is, for example, threaded.

The opening 32 extends perpendicularly to the orifice 30.

The spray head 14 defines a passage, the spray nozzle 16 being arranged in the passage of the spray head.

The spray head 14 defines a rear side 40 opposite the spraying of the coating product.

The spray head 14 has a main axis around which it extends.

The main axis of the spray head 14 coincides with the main axis X.

The spray head 14 has, for example, in this embodiment, at least one hole 33.

The or each hole 33 has a shape complementary to an indexing element described below, for example, a pin.

The or each hole 33 has, in the example shown, a circular shape.

The or each hole 33 extends parallel to the main axis of the spray head.

The spray nozzle 16 is integral with the spray head 14.

The angular position of the spray nozzle 16 relative to the spray head 14, around the main axis X, is fixed or maintained fixed, for example, as described below.

The spray nozzle 16 also extends, in this embodiment, around a main axis coinciding with the main axis X.

The spray nozzle 16 defines a passage 36 for spraying the coating product.

The spray nozzle 16 has, for example, an outlet in the form of a slot 38, so as to spray the coating product in the form of a flat jet.

The nozzle 16 is mounted on the spray head 14.

In this embodiment, the spray head 14 and the nozzle 16 are mounted on a seat holder 39, itself mounted on the body 12.

The mounting of the spray head 14 on the body 12 by the seat holder does not allow, in this embodiment, an angular locking between the body 12 and the spray head 14.

The ring 18 is, in this embodiment, mounted in the body 12 and held in position by the locking element 22.

The ring 18 connects, more particularly angularly along the axis X, the spray head 14 and the body 12.

The ring 18 extends, in this embodiment, around the main axis X.

The ring 18 has an external surface 44 and an internal surface 46, the internal surface 46 facing the main axis X, the external surface 44 being opposite the internal surface 46.

The ring 18 includes a shoulder 42 able to be held against the front face 28 of the body by the locking element 22.

The shoulder 42 is arranged on the external surface 44 of the ring 18.

The shoulder 42 extends over the entire circumference of the ring 18.

The ring 18 includes, on one side of the shoulder 42 along the main axis X, a so-called internal portion 48, the internal portion 48 being intended to extend into the passage 26 of the body 12.

The internal portion 48 extends against an internal wall of the outlet of the passage 26.

When the shoulder 42 extends against the front surface 28, the ring 18 is connected to the passage in a fluid-tight manner.

The ring 18 has at least one cutout 50, more particularly extending parallel to the main axis X, in this embodiment, two cutouts.

The ring 18 has as many cutouts 50 as the head 14 has holes 33.

The or each cutout 50 has a shape complementary to an indexing element, for example, a pin.

The cutouts 50 are, for example, arranged on the same diameter of the ring 18.

The at least one cutout 50 is, in this embodiment, provided on a circumferential protrusion 52.

The protrusion 52 extends in relief from the internal wall 46 of the ring 18.

The internal wall 46 has a cylindrical shape except for the protrusion 52.

The protrusion 52 extends at least over a portion of a circumference of the ring 18, more particularly, in this embodiment, over an entire circumference of the ring.

The at least one cutout 50 completely or partially traverses the protrusion in a direction parallel to the main axis X.

The or each cutout 50 has a hollow shape complementary to at least one indexing element, described below, in this embodiment, an arc shape.

The hole(s) 33 and the cutout(s) 50 are arranged, respectively, on the head 14 and on the ring 18, so that, when they are angularly aligned around the main axis X, a respective indexing element, in this embodiment, a pin, passing through a hole 33 cooperates with a corresponding cutout 50.

In this embodiment, each hole 33 is aligned in the axial direction with the corresponding cutout 50.

The circle of the arc has a diameter equal to the circle of the corresponding hole 33.

The ring 18 has, in this embodiment, a rotational symmetry around the main axis X, except for the at least one cutout 50.

The angular holding element 20 is an element for maintaining the angular position between the ring and the spray head.

In this embodiment, the angular holding element 20 includes at least one indexing element 54, in this embodiment, two, more particularly, in this embodiment, at least one pin.

The at least one pin is cylindrical in this embodiment.

Alternatively, the at least one indexing element has a shape different from a cylindrical pin.

The or each indexing element 54 is, for example, a separate piece in this embodiment.

Alternatively, the or each indexing element 54 is, for example, a protrusion of the head 14. The or each indexing element 54 is, for example, then made by machining the head. If applicable, the spray head 14 then does not have, for example, a hole 33.

Each indexing element 54 extends in the axial direction.

The or each indexing element 54 extends through a respective cutout 50 and the corresponding hole.

The or each indexing element 54 has a shape and dimensions such that there is no angular play between the head 14 and the ring 18, the or each indexing element 54 blocking any rotation of the head 14 relative to the ring 18.

When the or each indexing element 54 is a separate piece from the head 14, the or each indexing element 54 extends through the or a respective hole 33 of the spray head 14, protrudes from the hole 33 on the rear side 40, then protrudes in the axial direction of the spray head 14.

Thus, the angular holding element 20 maintains the angular position between the ring and the spray head.

In this embodiment, the angular holding element 20 of the angular position between the ring and the spray head also maintains the angular position between the spray head 14 and the spray nozzle 16.

The spray nozzle 16 also includes, for example, at least one cutout 56.

The spray nozzle 16 has as many cutouts 56 as the head 14 has holes 33.

The or each cutout 56 has a shape complementary to the indexing element 54.

The cutouts 56 are, for example, arranged on the same diameter of the spray nozzle 16.

The cutout(s) 56 are arranged on the nozzle 16, so that, when they are angularly aligned around the main axis X, a respective indexing element 54 passing through a hole 33 cooperates with a corresponding cutout 56.

In this embodiment, each hole 33 is aligned in the axial direction with the corresponding cutout 56.

Thus, in this embodiment, each hole 33 is aligned in the axial direction with a corresponding cutout 50 and a corresponding cutout 56.

The or each indexing element 54 extends through a hole 33, a cutout 56, and a cutout 50.

The cutout 56 is such that there is no angular play between the head 14 and the nozzle 16, the or each indexing element 54 blocking any rotation of the head 14 relative to the nozzle 16.

Thus, the angular holding element 20 maintains the angular position between the ring, the spray head, and the spray nozzle.

Having a maintenance of the angular position between the ring, the spray head, and the spray nozzle by a holding system allows for particularly precise angular adjustment.

Alternatively, the angular holding element 20 of the angular position between the ring and the spray head does not maintain the angular position between the spray head 14 and the spray nozzle 16, but only between the ring 18 and the head 14.

The or each indexing element 54 then extends, for example, only through a hole 33 and a cutout 50.

The angular position between the nozzle and the spray head is, for example, then maintained by a secondary angular holding system, including then, for example, at least one secondary indexing element, distinct from the at least one indexing element 54.

Each of the nozzle and the spray head then includes, for example, at least one secondary cutout. More particularly, the nozzle includes as many secondary cutouts as the spray head has and as the number of secondary indexing elements.

The or each secondary cutout has a shape complementary to the secondary indexing element.

Each secondary cutout of the nozzle is aligned in the axial direction with a secondary cutout of the head.

The secondary cutouts are, for example, arranged on a diameter of the respective piece different from the cutouts 50, 56.

The or each secondary indexing element extends through a secondary cutout of the nozzle and a secondary cutout of the head.

The or each secondary indexing element allows the angular position of the nozzle to be locked relative to the head.

Thus, the angular holding element 20 is able to maintain the angular position between the ring and the spray head, and the secondary holding element maintains the angular position between the spray head and the spray nozzle.

This allows for shorter, solid, and stable holding elements relative to the head, to perform the indexing between the head and the nozzle before screwing the head, and possibly to allow disassembly of the seat holder without touching the ring.

The locking element 22 is movable between a locking position, wherein it locks the angular position of the ring 18 relative to the body 12, and a release position, wherein it allows angular rotation of the ring 18 relative to the body 12.

The locking element 22 includes a rod 58 provided with a shoulder 60.

The shoulder 60 is arranged in an end portion of the rod 58.

In this embodiment, the rod 58 extends partially into the orifice 30.

The rod 58 is, for example, accessible from the lateral face 34 through the opening 32, i.e., a part of the rod 58 extends in view of the opening 32.

The end portion, including the shoulder 60, extends outside the orifice 30.

The rod 58 is able to move in translation in the orifice 30, more particularly only in translation along the axial direction.

Between the locking position and the release position, the rod 58 moves in translation along the axial direction.

The shoulder 60 extends in projection from the rod 58 towards the main axis X, for example in a direction perpendicular to the main axis X.

The shoulder 60 has a dimension such that it extends in view of the shoulder 42 along the axial direction.

The rod 58 is able to move between the locking position and the release position, such that, in the locking position, the shoulder 60 exerts a force pressing the ring 18 against the body 12 along the axial direction, more particularly against the front face 28 of the body 12 along the axial direction.

In the locking position, the shoulder 60 more particularly exerts a force pressing the shoulder 42 against the front face 28.

This prevents any movement, including rotation, between the ring 18 and the body 12.

In the release position, the rod 58 is moves in translation, so that the shoulder 60 moves away from the body 12.

Thus, in the release position, the rod 58 does not press the ring 18 against the body 12, allowing the ring 18 to be moved relative to the body 12, particularly in rotation around the main axis X.

The rod 58 advantageously has, for example, a recess 62.

The recess 62 extends in view of the opening 32, when the rod 58 is in the locking position, and also when the rod 58 is in the release position.

The recess 62 has, for example, in this embodiment, a chamfer 64.

The chamfer 64 forms an end of the recess opposite the shoulder 60.

The chamfer 64 forms a slanted surface relative to the axial direction and the radial direction, i.e., perpendicular to the main axis X.

The gun 10 further includes a screw 66.

The screw 66 is arranged in the opening and is able to be screwed around a screwing axis to a position of holding the rod, wherein the screw extends against the recess 62 of the rod, more particularly, in this embodiment, against the chamfer 64 of the recess 62.

In the position of holding the rod, the rod 58 is held in position, more particularly in the locking position.

The chamfer 64 is such that, when the screw 66 is screwed to the position of holding the rod, the rod 58 is moved towards the locking position, more particularly the rod 58 is driven in the axial direction towards the body 12, until it abuts against the shoulder 42.

When the screw 66 is not in the position of holding the rod, the rod 58 is movable in the axial direction, more particularly between the locking position and the release position.

The outer ring 24 partially surrounds the spray head 14.

The outer ring 24 extends in the axial direction between a rear end portion 68 and a front end portion 70.

The outer ring 24, more particularly the rear end portion 68, is able to be screwed to the body 12, more particularly to the lateral surface 34 between the front face 42 and the opening 32.

The front end portion 70 includes a shoulder 72, the shoulder being intended to extend against a rim 74 of the spray head 14, more particularly against the rim 74 of the front face of the spray head, opposite the rear side 40.

The outer ring 24 is able to be moved, in this embodiment, by screwing onto the body 12, in the axial direction, between a final position and at least one adjustment position.

The final position corresponds to the maximum screwing position of the outer ring 24 on the body 12.

In the final position, the shoulder 72 exerts a force on the spray head 14 in the direction of the body 12.

The at least one adjustment position corresponds, in this embodiment, to any intermediate screwing position of the outer ring on the body, allowing movement of the head 14 relative to the outer ring 24.

In a particular embodiment, the gun 10 is provided with a system for marking the angular position of the ring 18 relative to the body 12.

The marking system includes, for example, an angular marking around the outlet on the front face 28 of the body 12 and at least one mark on the external face 44 of the ring 18, more particularly at the protrusion 42.

Alternatively, the marking system includes, for example, an angular marking on the external face 44 of the ring 18, more particularly at the protrusion 42, and at least one mark around the outlet on the front face 28 of the body 12 or on the locking element 22, more particularly the shoulder 60 of the rod.

The marking system thus allows the angular position of the ring 18 relative to the body 12 to be marked.

This allows, in particular, the angular position to be reproduced on another gun or, for example, if the entire set of parts needs to be disassembled.

The invention also relates to a ring adapted to extend between a body of a coating product spray gun and an assembly including a spray head and a spray nozzle, the ring being as described above.

The invention also relates to an assembly including a spray head for a coating product spray gun and at least one indexing element, the spray head and the indexing element being as described above.

The invention also relates to a method for indexing an angular position between a body and a spray head of a gun as described above.

The method includes the following operations, in this order:
Providing the gun 10 as described above, the locking element 22 being in the release position,
Positioning the ring 18 relative to the body 12 in a relative angular position, and
Moving the locking element 22 to the locking position, so that the ring 18, and thus the spray head 14, are maintained in the relative angular position relative to the body 12.

In the described example, in the providing operation, the screw 66 is not screwed to the position of holding the rod 58. Thus, the screw 66 does not press against the recess 62.

Furthermore, in the providing operation, the outer ring 24 is, for example, not mounted on the gun 10 or it is in an adjustment position.

Following the providing operation, the ring 18 is movable in rotation relative to the body 12, around the main axis X.

The ring 18 is rotationally integral with the head 14, and here with the nozzle 16, so that by adjusting the angular position of the ring 18 relative to the body 12, the angular position of the head 14, and, in this embodiment, of the nozzle 16, relative to the body 12 is adjusted.

In a particular embodiment, the adjustment of the angular position is, for example, performed using the marking system as described above, for example, by aligning the at least one mark with a value or location of the angular marking.

After positioning the ring 18 relative to the body 12 in the relative angular position, the locking element 22 is moved to the locking position, so that the relative angular position is maintained.

More particularly, in this embodiment, the screw 66 is screwed to the position of holding the rod.

The cooperation of the screw 66 with the chamfer 64 causes a movement of the rod 58 towards the body 12, and thus in the locking position.

The method further includes, in this embodiment, after the operation of moving the locking element 22 to the locking position, an operation of positioning the outer ring 24 in the final position.

The outer ring 24 is, in this embodiment, screwed onto the body 12 to the final position, i.e., until the shoulder 72 abuts against the spray head.

If, after indexing the body and the spray head of a gun in the angular position, a change of angular position to a second angular position is desired, the method further includes the following operations, in this order:
if applicable, moving the outer ring 24 to the adjustment position or removing the outer ring,
moving the locking element 22 to the release position,
angularly moving the ring 18 relative to the body 12 to the second angular position,
moving the locking element 22 to the locking position, and
if applicable, positioning the outer ring 24 in the final position.

More particularly, in this embodiment, the screw 66 is unscrewed from the opening, so that it no longer presses on the recess 62, and in particular the chamfer 64. The rod 58 is then movable to the release position.

The movement of the locking element 22 to the locking position is, for example, performed as described above.

Thus, the body and the spray head, by means of the ring, are now maintained in the second angular position.

In case of maintenance of the gun requiring disassembly of the head from the body, the head, and, in this embodiment, the nozzle, are disassembled from the rest of the gun 10.

More particularly, in this embodiment, the outer ring is disassembled, then the head and the nozzle are disassembled from the rest of the gun.

The ring 18 remains in place and held in position relative to the body 12 thanks to the locking element 22.

The at least one indexing element 54 remains, for example, with the head 14, particularly in the corresponding hole 33 or as a protrusion.

After the maintenance operation requiring disassembly of the head from the body, the head, and, in this embodiment, the nozzle, are reassembled on the body, aligning the at least one cutout and the at least one hole with the at least one indexing element.

If applicable, the outer ring 24 is then reassembled on the body in the final position.

The angular holding element thus allows the angular position between the ring and the head, and the locking element between the ring and the body, to be maintained.

Thus, by means of the invention, the head, and, in this embodiment, the nozzle, are reassembled relative to the ring, and thus to the body, in the same angular position as previously.

The adjustment of the angular position has therefore not been lost by the disassembly of the head.

1. A coating product spray gun comprising:
a body;
a spray head defining a passage;
a spray nozzle arranged in the passage of said spray head;
a ring connecting said spray head and said body;
an angular holding element of an angular position between said ring and said spray head; and
a locking element movable between a locking position, in which it locks the angular position of said ring relative to said body, and a release position, in which it allows angular rotation of said ring relative to said body.

2. The gun according to claim 1, wherein said locking element comprises a rod provided with a shoulder, the rod moving between the locking position and the release position, such that, in the locking position, the shoulder exerts a force pressing said ring against said body in an axial direction.

3. The gun according to claim 2, wherein said spray head has a main axis, said rod moving between the locking position and the release position in translation along the axial direction, the axial direction being parallel to the main axis of said spray head.

4. The gun according to claim 2, wherein said body has an orifice opening onto a front face of said body, said ring extending against the front face of said body in the locking position of said locking element, said rod extending partially into the orifice, said body having an opening extending between a lateral face of said body and the orifice, so that said rod is accessible from the lateral face through the opening.

5. The gun according to claim 4, comprising a screw, the opening being threaded, the screw being arranged in the opening and being able to be screwed around a screwing axis to a position of holding said rod, wherein the screw extends against a recess of said rod, the recess having a chamfer, the chamfer being such that, when the screw is screwed to the position of holding said rod, said rod is moved towards the locking position.

6. The gun according to claim 1, wherein said angular holding element also maintains the angular position between said spray head and said spray nozzle.

7. The gun according to claim 1, wherein said angular holding element comprises at least one indexing element, said ring having at least one complementary cutout of the at least one indexing element, said spray head having at least one complementary hole of the at least one indexing element, the or each indexing element extending through the respective cutout and the respective hole.

8. An assembly comprising:
a spray head for a coating product spray gun;
at least one indexing element, said spray head having at least one complementary hole of the at least one indexing element; and
a ring adapted to extend between a body of the coating product spray gun and said spray head, the ring having at least one complementary cutout of said at least one indexing element, the at least one cutout being arranged so that the indexing element extending through the respective cutout extends through the at least one hole of said spray head.

9. An assembly comprising:
a spray head for a coating product spray gun;
at least one indexing element, said spray head having at least one complementary hole of the at least one indexing element, said spray head defining a rear side opposite the spraying of the coating product and a front side opposite the rear side, the or each indexing element extending through the or a respective hole, protruding from the hole on the rear side then on the front side of said spray head in an axial direction of said spray head.

10. A method for indexing an angular position between a body and a spray head of a gun, the method comprising:
providing the gun according to claim 1, the locking element being in the release position;
positioning the ring relative to the body in a relative angular position; and
moving the locking element to the locking position, so that the ring, and thus the spray head, are maintained in the relative angular position relative to the body.
